(19) United States
(12) Patent Application Publication
(10) Pub. No.: US 2019/0316999 A1
(43) Pub. Date: Oct. 17, 2019

(54) WOUND ROLL QUALITY INSTRUMENT AND METHOD

(71) Applicant: THE BOARD OF REGENTS FOR OKLAHOMA STATE UNIVERSITY, STILLWATER, OK (US)

(72) Inventors: James Keith Good, Stillwater, OK (US); Ronald Eugene Markum, Stillwater, OK (US)

(73) Assignee: THE BOARD OF REGENTS FOR OKLAHOMA STATE UNIVERSITY, STILLWATER, OK (US)

(21) Appl. No.: 16/305,984

(22) PCT Filed: Jun. 1, 2017
(86) PCT No.: PCT/US2017/035506

§ 371 Date: Nov. 30, 2018

Related U.S. Application Data
(60) Provisional application No. 62/344,091, filed on Jun. 1, 2016.

(51) Int. Cl. G01N 3/42; G01N 3/06

(52) U.S. Cl. CPC G01N 3/42; G01N 3/066; G01N 2203/0085; G01N 2203/0274; G01N 2203/0078

(57) ABSTRACT

This disclosure relates generally to enabling a user to (1) determine the radial stiffness of the outer surface of a winding or wound roll, and (2) when coupled with a winding/contact model results in a virtual instrument allowing the user to explore the residual stresses due to winding in roll-to-roll manufacturing process machines, and (3) allows the user to predict winding defects and hence roll quality based upon the known residual stresses. Wound roll models require the input of a radial modulus of elasticity which is state dependent on interlayer pressure. The hardware of the disclosure can be used to determine this radial modulus and serves to enable the user to (1) use winding/contact models and (2) with measurements made during or after winding enable the user to estimate the winding residual stresses.

### CROSS REFERENCE TO RELATED APPLICATIONS

This application claims the benefit of U.S. Provisional Patent Application Ser. No. 62/344,091 filed on Jun. 1, 2016, and incorporates said provisional application by reference into this document as if fully set out at this point.

### TECHNICAL FIELD

This disclosure relates generally to enabling roll-to-roll additive manufacturing methods and, more particularly, to systems and methods for measuring parameters associated with the wound roll.

### BACKGROUND

Roll-to-roll (R2R) additive manufacturing methods pervade many automated process industries today. R2R manufacturing methods require one or more substrates known as webs to be transported continuously through processes which add value to a web and ultimately result in a commercial product. The webs are very long compared to their width and thickness dimensions and the only means by which these webs can be stored with minimal damage while they await further processing is by winding them into rolls. Storage is a necessity, as each web process requires a unique web velocity. Therefore, webs must be wound into rolls at the end of a process. The rolls are then transported to the next web process machine where they will be unwound and processed again. Webs can be unwound and rewound many times for subsequent processing prior to conversion to a final product. The web value increases after each process, thus damage loss due to winding becomes more costly based on the number of manufacturing processes that have been completed.

Numerous instruments have been previously developed or adapted that attempt to measure roll hardness. The majority of these instruments can be described as dynamic hardness testers. Some of these testers can be described as deceleration devices where a wound roll is struck and the deceleration of the striker is measured. U.S. Pat. Nos. 3,425,267 and 5,079,728A are examples of these technologies. Other testers can be described as coefficient of restitution devices where a projectile is launched towards the roll surface and the projectile velocity is compared before and after impact. U.S. Pat. Nos. 4,034,603 and 5,176,026 are examples of that technology.

Prior art attempts to determine static and dynamic hardness testers might have one or more of the following limitations:
1. These devices have output units which are unique to the device and these units cannot be converted to engineering units of strain, stress or pressure in the web. Web defects are quantifiable only in engineering units. The Acoustic Roll Structure Gage (U.S. Pat. No. 5,535,627 A) sought to remove that shortcoming by combining a dynamic shock wave measurement with a mechanics winding model that would predict the strains, stresses and pressures within the wound roll. The shock wave was induced by dynamically striking the roll, similar to the dynamic hardness testers, which leads to the second shortcoming.
2. The dynamic hardness testers are not universally applicable on all wound rolls. Rolls of some web materials yield no output or output which cannot be correlated with any relative measure of hardness. This is at least partially due to nonlinear strike dynamics and internal wave reflections that occur at the multitude of web layer interfaces within the wound roll.
3. The output of a dynamic hardness tester may make little or no sense to the operator. Static hardness testers (Shore A, Shore D, etc.) yield higher values of hardness for harder surfaces. This may or may not be true for dynamic hardness testers.
4. Static hardness testers exert high contact pressures. A Shore A hardness tester exerts about 2,400 psi of contact pressure for a hardness reading of 100 units. Compared to winding contact pressures that may range from a few psi to several hundred psi, the 2400 psi contact pressures of the Shore A tester are extremely large and disturb the roll surface that is being measured. This makes commercial hardness testers of little or no use for inferring wound roll pressures.
5. A final shortcoming is the potential for roll and web damage due to the dynamic impact from the tester. It is not uncommon for these tests to cause inelastic deformation in the form of visible dimples at the strike point on the wound roll. This deformation is often permanent and is seen when unwinding the web in a subsequent process and results in process imperfections.

Before proceeding to a description of the present invention, however, it should be noted and remembered that the description of the invention which follows, together with the accompanying drawings, should not be construed as limiting the invention to the examples (or embodiments) shown and described. This is so because those skilled in the art to which the invention pertains will be able to devise other forms of this invention within the ambit of the appended claims.

### SUMMARY OF THE INVENTION

According to a first embodiment, the teachings herein make it possible for a user to determine the radial stiffness of the outer surface of a winding or wound roll, and, when coupled with a winding/contact model, results in a virtual instrument that can allow the user to explore the residual stresses due to winding in roll-to-roll manufacturing process machines. Additionally, various embodiments will allow the user to predict winding defects and hence roll quality based upon the known residual stresses. Wound roll models require the input of a radial modulus of elasticity which is state dependent on interlayer pressure.

The hardware of an embodiment can be used to determine this radial modulus and serves to enable the user to use winding/contact models and, with measurements made during or after winding, enable the user to estimate the winding residual stresses.

In more particular, an embodiment of the apparatus is designed to measure, record, compute, or otherwise determine radial stiffness. The major components include but are not limited to devices that measure applied force, indenter displacement, an indenter of known diameter, a housing to contain and constrain the afore described components, and component(s) or systems to record, transmit, perform calculations, or otherwise perform operations on the measured test data.

Various embodiments can be used to create a profile of radial stiffness with respect to winding radius and across the roll width. Additionally, disclosed herein is an apparatus for evaluating the true winding stress and the actual winding residual stresses in the wound roll. Further, an embodiment is disclosed that provides a method for improving the quality of wound rolls by avoidance of defects that can be predicted with knowledge of winding residual stresses.

Additionally, some variations can be used iteratively in connection with a winding motel to predict defects inside and on the surface of the roll. This combination of a radial stiffness tester and the methods disclosed herein provide a method of improving wound roll quality not available in any other form.

According to another embodiment there is provided an apparatus for measuring a radial stiffness of a wound roll, comprising: a housing; an indenter, said indenter having a first end external to said housing and a second end internal to said housing; a force sensor within said housing and in mechanical communication with said indenter, said force sensor at least for measuring a force when said force is applied to said housing to urge said indenter against the wound roll; a displacement sensor within said housing, said displacement sensor at least for measuring a displacement of said indenter when said force is applied to said housing to urge said indenter against the wound roll; and, a CPU in electrical communication with said force sensor and said displacement sensor, said CPU at least for reading said force from said force detector and said displacement from said displacement sensor.

According to still another embodiment there is provided an apparatus for measuring a radial stiffness of an object, comprising: an indenter; a pressure contact area in mechanical communication with said indenter; a force sensor in mechanical communication with said indenter, said force sensor at least for measuring a force when said force is applied to said pressure contact area to urge said indenter against the object; a displacement sensor, said displacement sensor at least for measuring a displacement of said indenter when said force is applied to said pressure contact area to urge said indenter against the object; and, a CPU in electrical communication with said force sensor and said displacement sensor, said CPU at least for continuously reading said force from said force detector and said displacement from said displacement sensor as said force is applied.

According to an additional embodiment, there is provided a method of identifying defects in a wound roll of material, comprising the steps of: accessing values of Tw, h, R_{core}, Rₒᵤₜ, E_{□}, and Eᵣ for said material, where, Tw is a winding tension of said wound roll, h is a thickness of caliper of the material, R_{core} is an outside radius of a core of said wound roll, Rₒᵤₜ is an inner radius of the wound roll, E_{□} is modulus of the material in the machine direction, Eᵣ is the modulus of the web in the radial direction, and E_{c} is a modulus of a core on which the material is wound; using a winding model to obtain a relationship between Eᵣ and r, where r is a radial distance from a center of said wound roll; using at least Eᵣ and one or more of Tw, h, R_{core}, Rₒᵤₜ, E_{□}, and Eᵣ to calculate a contact model, thereby producing one or more values of K_{code}, where K_{code} is a slope of relationship between force and displacement from said contact model; obtaining a plurality of different force and displacement values at a single point on said wound roll; using said plurality of force and displacement values to obtain one or more values of Kₜₑₛₜ at said single point on said wound roll; comparing said one or more value of K_{code} with said one or more values of Ktest; if said one or more K_{code} values are approximately equal to said one or more Kₜₑₛₜ values, conclude that a winding tension is correct; and, if said one or more K_{code} values is significantly different from said one or more Kₜₑₛₜ values, conclude that said winding stress is not correct; and, if said one or more K_{code} values is significantly different from said one or more Kₜₑₛₜ values, modifying Tw and performing the above steps again with Tw replaced by said modified Tw until Kₜₑₛₜ is not significantly different from Kcode.

The foregoing has outlined in broad teems some of the more important features of the invention disclosed herein so that the detailed description that follows may be more clearly understood, and so that the contribution of the inventors to the art may be better appreciated. The invention is not to be limited in its application to the details of the construction and to the arrangements of the components set forth in the following description or illustrated in the drawings. Rather, the invention is capable of other embodiments and of being practiced and carried out in various other ways not specifically enumerated herein. Finally, it should be understood that the phraseology and terminology employed herein are for the purpose of description and should not be regarded as limiting, unless the specification specifically so limits the invention.

### BRIEF DESCRIPTION OF THE DRAWINGS

These and further aspects of the invention are described in detail in the following examples and accompanying drawings.

FIGS. 1A and 1B contain schematic illustrations of a first embodiment. FIG. 1A is an exemplary embodiment of a hardware device designed according to the teachings herein. FIG. 1B is a schematic illustration of a force versus deformation curve for an embodiment.

FIG. 2 contains a schematic illustration of a second embodiment.

FIGS. 3A-3D contains plots of residual winding stress and contact model/test results for a particular variation. FIG. 3A contains a plot of roll radius versus pressure (psi). FIG. 3B contains a plot of roll radius versus tangent stress (psi). FIG. 3C contains a plot of roll radius versus axial stress. FIG. 3D contains a plot of radial penetration versus radial force for two different values of Tw.

FIG. 4 contains a schematic illustration of the sort of output that might be obtained according to an embodiment by using the stiffness testing apparatus 100 or 200 on a wound roll.

FIG. 5 illustrates an operational flow suitable for use with an embodiment.

FIG. 6 illustrates an operational configuration that could be useful with some embodiments.

FIG. 7 contains a schematic illustration of an embodiment being used to test the stiffness of a stack of items.

FIG. 8 illustrates schematically an embodiment might be used to test for defects in a wound roll by sampling the roll repeatedly along its longitudinal length.

FIG. 9 contains a cross sectional view of another embodiment.

### DETAILED DESCRIPTION

While this invention is susceptible of embodiment in many different forms, there is shown in the drawings, and will herein be described hereinafter in detail, some specific embodiments of the instant invention. It should be understood, however, that the present disclosure is to be considered an exemplification of the principles of the invention and is not intended to limit the invention to the specific embodiments or algorithms so described.

The current development eliminates various shortcomings of certain prior art approaches instruments by making a measurement of the static or steady state radial stiffness on the outer surface of the wound roll. Radial stiffness is determined by the relationship between an applied force on a material and the resulting deformations. The radial stiffness, in most cases, will increase as the user increases the applied force. As the applied force is increased, the contract pressure and hence the state dependent radial and shear modulus will increase. The increase in modulus with pressure is responsible for the increase of radial stiffness with the applied force. There may be cases, due to material properties or the small magnitude of the applied force that the radial stiffness may be nearly constant. These stiffness measurements start at zero contact pressure and continue up to maximum contact pressures defined by the user.

For purposes of the disclosure contained herein, these symbols are defined as follows:
Tw Winding tension, tension in the web as it enters the wound roll. (load/unit area)
Eᵣ Radial modulus, the modulus of the web in the radial direction. Radial modulus in a general sense is given as a function of wound roll pressure and the previously determined K₁, K₂ coefficients as shown in Eq. (2). (load/unit area)
P Pressure at the point in the wound roll where Er is to be determined. (load/unit area)
K₁ Material constant, determined by stack test. (load/unit area)
K₂ Material constant, determined by stack test. (dimensionless)
εᵣ Strain. (dimensionless)
Rᵢₙ Inner radius of the wound roll, equivalent to the outside radius of the core on which the web is wound. (length)
Rₒᵤₜ Outer radius of the wound roll. (length)
h_{web} Thickness of caliper of the web. (length)
E_{θ} Modulus of the web in the machine direction. (load/unit area)
E_{c} Modulus of the core on which the web is wound. (load/unit area)
ν Poisson's ratio. (dimensionless)
R_{core} Same as Rᵢₙ
r Radial position of interest in the wound roll. (length)
σ_{θ} Stress of the web in the circumferential direction. (load/unit area)
σ_{z} Stress of the web in the axial direction. (load/unit area)
F Force. (load)
u Deformation. (length)

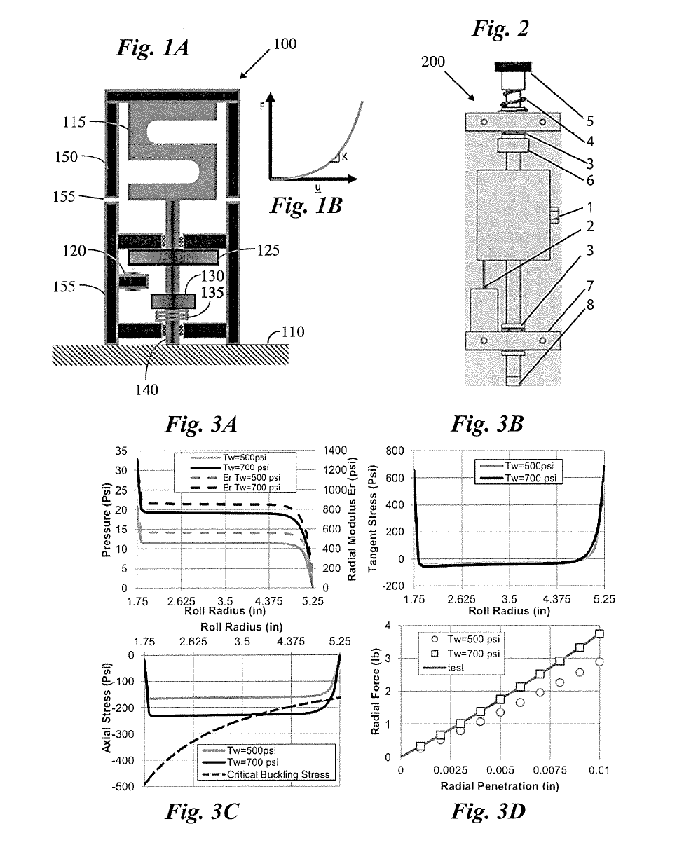

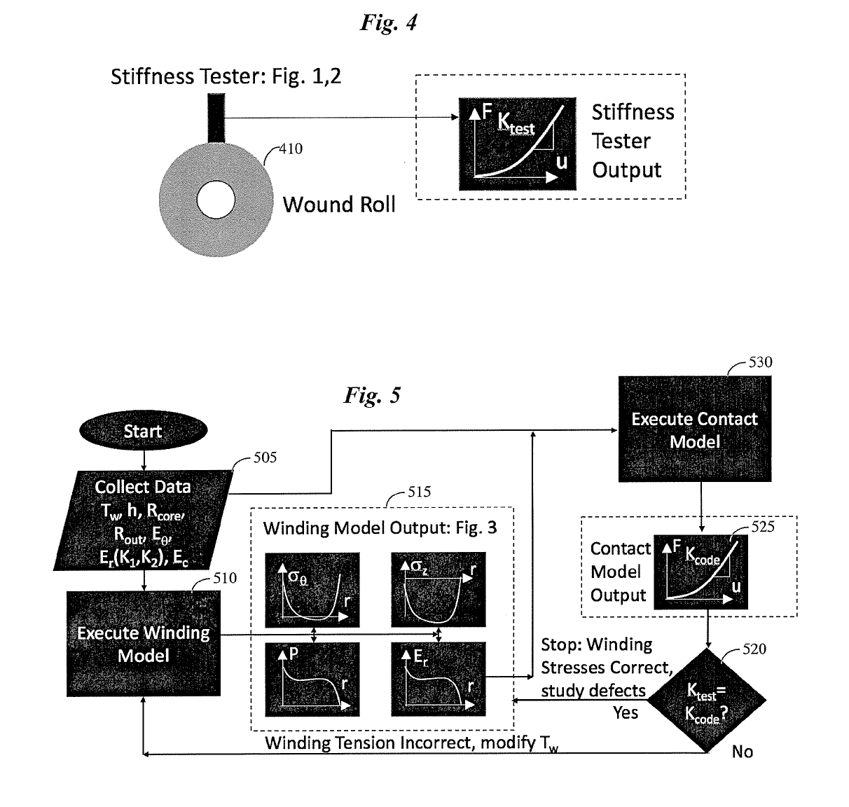

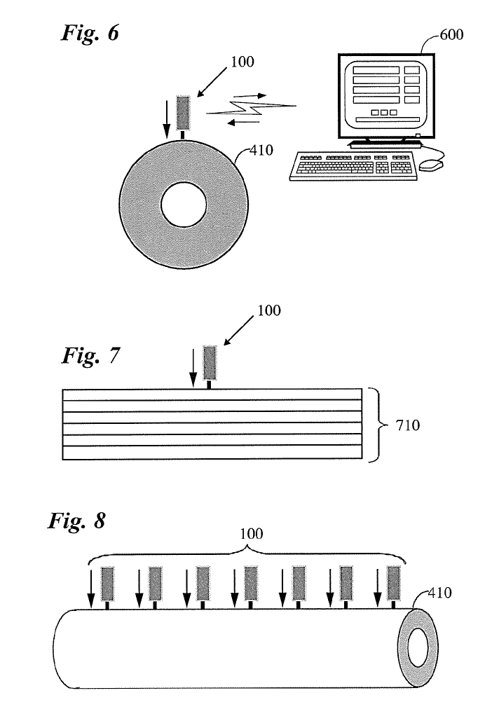

Various aspects of a first embodiment are shown in FIGS. 1A-1B. The device 100 is designed to be pressed against a wound roll 110 (shown as the hashed foundation at the bottom). Load and displacement transducers will be arranged to make repeated stiffness and pressure measurements as described below. The device is not intended to be limited by the selection, location, configuration, or number of the transducers.

In the embodiment of FIGS. 1A-1B, there is a sensor 115 for measuring the force that is applied when the indenter 140 is pressed against a wound roll 110. In the embodiment of FIG. 1, the sensor/force measuring device 115 (e.g., a load cell, or any transducer capable of measuring a load) is situated within a housing that includes a cap 150 that is movable with respect to its housing base 155. The cap 150 is one example of a pressure contact area as that term is used herein. In this embodiment there is an engineered gap 155 between the cap 150 and base 155 but there are many other ways to configure the device 100 so that the top and bottom are movable with respect to each other (e.g., consider two cylinders with one nested inside of the other). In some cases the gap 155 or an internal stop will be configured to limit the maximum pressure that can be exerted by the indenter 140 so that the material that is being tested is not damaged. Other embodiments are envisioned that do not require a gap or movement of the parts.

The force measuring device 115 is in mechanical communication with an indenter 140 which is designed to come into contact with the material that is to be tested 110 as is more fully described below.

Within the device 100, there is a sensor for measuring displacement 120, which might be a DCDT (Direct Current Differential Transformer) or something similar. Those of ordinary skill in the art will readily be able to devise alternatives. Additionally provided in this embodiment are a displacement stop plate 125, a return spring 135, and a spring retainer 130.

Not pictured is a communications module (e.g., Bluetooth®, WiFi, etc.) or communications interface (e.g., a serial port, a USB port, etc.) which can be used to communicate force and displacement readings to an external data recorder or computer. Alternatively, instead of or in addition to the foregoing, a CPU processing unit might be resident on the device and in electrical communication with the force measuring device 115, and the displacement sensor 120. The CPU could have some amount of local storage and the computational ability to read measurements from the force measuring device 115 and displacement sensor 120. It further could optionally be programmed to calculate and display radial stiffness measurements directly to a user as the device 100 is used, preferably via a display device that is part of, or in communication with, the device 100. The CPU will likely be internal to the housing of the device 100 but it could also be external is that were desired.

The CPU might be any sort of active device which is designed to execute computer instructions according to its programming, including, for example, a conventional microcontroller or microprocessor. More generally, the term “CPU” as used herein minimally requires a device that is programmable in some sense and is capable of recognizing signals from a force sensor and displacement sensor. Of course, these sorts of modest requirements may be satisfied by any number of programmable logic devices (“PLDs”). The CPU might, alternatively or additionally, be embedded in another device (e.g., in a Bluetooth chip, or WiFi module, etc.). Thus, for purposes of the instant disclosure the terms “processor,” “microprocessor” and “CPU” should be interpreted to take the broadest possible meaning, and such meaning is intended to include any PLD or other programmable device of the general sort described above. The term CPU should also be interpreted to include multiple CPUs if, for example, one CPU reads the displacement sensor and another reads the force sensor.

An alternative embodiment is shown in FIG. 2. In this figure, the variation 200 comprises a loading knob 5 which is in mechanical communication with an indenter 8. As before, there is a displacement transducer 2 and a load cell 1. Additionally, there are linear bearings 3 and 6, a return spring 4, and a base plate 7 which might be part of the housing, (not shown). The loading knob 5 may also be referred to herein as an example of a pressure contact area.

In operation, the device 100 is pressed against the material that is to be measured which would typically be either wound onto a roll or assembled into a stack of material (e.g., the stack 710 of FIG. 7). An external force is applied to the top cap 150 of the device 100, e.g., by having a user manually or a machine automatically press the device 100 downward onto the roll 100 or other material that is to be measured. The applied force is transferred from the indenter 140 which is in contact with the material that is to be tested to the force measuring device 115. Force measuring device 115 reports the measured force to a CPU processing unit which continuously reads the force measuring device 115 (e.g., every millisecond) as the device 115 is pressed with increasing firmness into the subject material. Note that the CPU might either be external to the device or external to it. As force is applied to the top cap 150, the indenter 140 is displaced deeper into the measured material and simultaneously is pushed back toward the housing of the device 100 by an amount that is sensed by displacement measuring device 120. The amount of displacement is continuously read (e.g., every millisecond) by the CPU. The maximum indention may be (but is not to be required) limited by mechanical stops incorporated into the housing 100 or other part of the apparatus. In FIG. 1A, the maximum permissible amount of displacement is controlled by the gap between the top cap 150 and the base 155 of the device 100.

After a test of material is concluded and pressure is removed therefrom, the indenter 140 may be (but is not required to be) returned to its original position by a return spring 135. Force measuring components 115 may include but not limited to load cells, force meters, spring scales, optical means or any other embodiment of a force measuring component. Displacement measuring components 120 may include but are not limited to DCDT (direct current displacement transducer), LVDT (linear variable differential transformer), linear or rotary potentiometers, optical devices, capacitance devices or any other embodiment of a displacement measuring device.

Given the force displacement pairs calculated during the previous test, the CPU in the device 100 itself, or a computer 600 external to the device 100, will prepare a force versus deformation curve (e.g., a curve of the sort illustrated in FIG. 1B) for the tested material. As was explained above, when the device 100 is pressed against the roll 410 or stack of material, the force and deviation are repeatedly measured as the force increases, preferably at intervals of 1 millisecond, 5 milliseconds, 10 milliseconds, etc., but, of course, the sample interval is a parameter that might depend on the material that is being measured and the needs of a user. In brief, the sample rate should be frequent enough that multiple force versus displacement measurements are obtained each time the device 100 is used. An estimate of the radial stiffness, K, can then be calculated from the collected data pairs by curve fitting and estimating the resulting slope. Note that it should not be inferred from the foregoing that an actual plot of force versus deviation will be created and shown to the user, although it might be. In some instances, that data pairs will be merely organized in computer memory or other storage so that a curve fitting algorithm of the sort discussed below can be applied.

This device can be embodied in handheld form or incorporated into a mechanical system that can make measurements of the surface stiffness of a stationary wound roll or a rotating roll for measurement during winding. As described previously, if plotted the measurements will yield a force (F) versus deformation (u) curve of the form shown in FIG. 1B. The slope of this curve (K) is not typically constant and could be affected by the internal pressures, stresses and material properties (including the radial modulus) of the wound roll. The inventive device can be used to make measurements at numerous locations across the width of a wound roll (e.g., FIG. 8), in order to test for a difference in stiffness which might be associated with a defect in the winding. This would produce measurements similar in some ways to those produced by dynamic testers, but the instant invention will produce output for all web materials, with harder rolls producing a higher stiffness. Further, the inventive device can be used as a virtual instrument in conjunction with winding and contact models to infer the pressures and stresses within the wound roll.

Winding models output the internal pressures and stresses within a wound roll as a function of roll radius. The inputs typically include the tension in the outer layer of a winding roll, the web modulus of elasticity in the tangential and radial directions, web thickness, inner and outer radius of the wound roll and the core stiffness. The radial modulus is state dependent on pressure.

An additional aspect of various embodiments is that the radial modulus can be measured by using devices of the sort generally illustrated in FIGS. 1A and 2 on a stack of web layers in an off-line test. Assume, for purposes of an embodiment that there is a logarithmic form for pressure versus strain:

[symbol] (1)

where P=pressure (units of load per unit area), K₁=a material constant (units of load per unit area), K₂=a material constant (dimensionless), and εᵣ=strain (dimensionless). The derivative of the pressure (P) with respect to the normal or radial strain (εₜ) establishes the radial modulus:

$$\frac{dP}{d {ɛ}_{r}} = {E}_{r} = {K}_{2} ( P + {K}_{1} ) \qquad ( 2 )$$

where K₁ and K₂ are determined by testing stacks of web layers in compression. The measured forces from the device shown in FIGS. 1A and 2 can be divided by the contact area of the foot to infer pressure and the measured deformation in the web layers can be divided by the uncompressed stack height to infer the normal strain.

A least square curve fit method can then be used to fit expression (1) to the test data and produce the empirical values of K₁ and K₂. Expression (1) works reasonably well for many web materials but does not necessarily work well for all webs. Those of ordinary skill in the art will readily be able to devise alternative functional forms that might be fit to such data. It has been shown that in some instances the modulus is state dependent on pressure through a polynomial expression. However, one aspect of the disclosure herein is that the device can be used to establish the radial modulus regardless of the expression chosen to characterize the radial modulus.

Once a winding model has been executed a contact model can be developed. The winding model output includes the pressures, stresses in each layer, and the state dependent radial modulus as a function of wound roll radius. This information is required by the contact model. This model simulates the contact between the devices of FIGS. 1A and 2 and the wound roll. The output of this model is a force versus deformation curve similar in general concept to that shown in FIGS. 1B and 3D. In FIG. 1B the radial stiffness is K, the slope of the curve.

If the inputs to the winding model are accurately known, the measured force versus deformation curve from the device of FIGS. 1A and 2 should match the curve output by the contact model. If this is true, the internal stresses within the wound roll are known, potential defects can be assessed, and hence the roll quality can be assessed. When the curves do not match, it will be assumed that one or more inputs given to the winding code are incorrect. The tension in the outer layer of a winding roll is an important input that is provided to a winding model. This tension has greater impact on the internal stresses, pressures and strains than all other inputs. However, the tension in the outer layer may not be well known due to minor web thickness variations across the web width which causes variation in the outer lap radius and results in uneven tension distribution over the web width. Additionally, rollers may be impinged into the outer surface of winding rolls to, for example, reject entrained air. These rollers induce slip and may further alter the tension in the outer layer. Therefore, winding tension can be varied as an input to the winding model which will in turn affect the starting radial modulus properties in the contact model. When the measured force versus deformation curves match that given by the contact model, the winding tension has become known. Whatever pressures, stresses and strains were output in the final execution of the winding model are those that should be used to predict winding defects and roll quality.

As an example, a polyester web 0.002″ thick, has the properties shown in Table 1 below:

TABLE 1
Winding Model Input Properties

| | | | | | |
|---|---|---|---|---|---|
| Rᵢₙ | 1.75 | in | Rₒᵤₜ | 5.25 | in |
| t_{web} | 0.002 | in | E_{θ} | 711,000 | psi |

| | | | | |
|---|---|---|---|---|
| E_{z} | 711,000 | psi | Eᵣ | 38.36(P(psi) + 3.19) |

| | | | | |
|---|---|---|---|---|
| ν_{θr} = ν_{zr} = ν_{zθ} | 0.3 | E_{c} | 3.8 | Mpsi |

Based on the total web tension and average web thickness in the previous example, it is estimated the winding tension stress (T_{w}) is 500 psi. Inner and outer wound roll radius, web modulus in the r, θ and z directions, Poisson's ratio and the core stiffness are given as inputs to the winding model. Examples of winding models suitable for use with various embodiments may be found in, among others, Hakiel, Z., 1987, “Nonlinear Model for Wound Roll Stresses,” Tappi J., 70(5), pp. 113-117, or Mollamahmutoglu, C. and Good, J. K. “Analysis of Large Deformation Wound Roll Models,”, ASME Journal of Applied Mechanics, V80, July 2013, pp. 041016-1-11, the disclosures of which are incorporated herein by reference as if fully set out at this point. Using a winding model, the wound roll pressures, tangential and axial stresses can be computed as shown in FIGS. 3A, 3B and 3C, respectively. After the winding model is executed, the radial modulus becomes known as a function of radius and is shown on a secondary axis overlaid on the pressure chart in FIG. 3A. Additional information generally related to the subject matter herein might be found in Pfeiffer, J. D., 1966, “Internal Pressures in a Wound Roll of Paper,” Tappi J., 49(8), pp. 342-347, the disclosure of which is incorporated herein by reference as if fully set out at this point.

Next, a contact model is calculated. The contact model is an nonlinear finite element model. This model is setup with the same inner and outer radius as the winding model, the width should be sufficient such that the vertical u deformations approach zero at the right boundary. The model is restrained at the lower surface by a constraint that simulates the stiffness of the core. At the beginning of execution each finite element has a radial modulus set as a function of radius per the computations shown in FIG. 3A.

The stylus, in this example ⅜″ in diameter, is impinged in increasing deformations (u) in the r direction. This will induce local pressures which will result in further increase in the radial modulus. At the end of each incremental deformation the average pressure in each finite element is computed and used to increase the radial modulus per the expression in Table 1 prior to the next increment of stylus deformation. Using this method the radial force versus penetration curve for the Tw=500 psi case was produced in FIG. 3D.

The device shown in FIGS. 1A and 2 was used to impinge a ⅜″ diameter stylus into the outside of the wound roll. This data is shown as “test” in the radial force versus penetration chart in FIG. 3D. Note the “test” result and “Tw=500 psi” contact model results do not agree. Now, an iterative process begins where the winding tension stress (T_{w}) is varied until the radial force versus penetration data from the contact model agree with that of the test results. Trial winding tension stress values are input to the winding model to obtain initial radial modulus data for the contact model which is executed again.

In this example, a match between test and model results is produced when the winding tension stress (T_{w}) approaches 700 psi, also shown in FIG. 3D. Now the internal stresses in the wound roll are known with confidence and can be used to predict defects. An example of axial buckling is shown in FIG. 3C. The axial stresses for a winding tension of 500 psi were less negative than the critical buckling stress shown in FIG. 3C. After the true winding tension was established at 700 psi, the axial stresses became more negative than the critical stress, therefore, buckling should be expected. To improve the quality of the wound roll, the winding tension should be decreased in subsequent windings. Rolls wound with a true winding tension of 500 psi induce less axial stress than the critical value (FIG. 3C), would have no buckles and improved roll quality.

Turning next to FIGS. 4 and 5, these figures illustrate how an embodiment might be used in practice. FIG. 4 illustrates schematically what the output from an embodiment (e.g., stiffness testing device 100 or 200) might look like.

FIG. 5 illustrates in greater detail how an embodiment might be used in practice. As an initial step 505, quantities relevant to the material being round and the wound roll are determined. These quantities might include T_{w} (winding tension stress), h (thickness of caliper of the web), R_{core} (the inner radius of the wound roll), Rₒᵤₜ (outer radius of the wound roll), E_{θ} (modulus of the web in the machine direction), Eᵣ(K₁,K₂) (radial modulus), and E_{c} (modulus of the core on which the web is wound).

Preferably the quantities K₁ and K₂ will have been previously determined using an embodiment via a “stack test” of the sort explained previously using equations (1) and (2) above as described above.

From these quantities, a winding model for the subject material 510 can be calculated according to methods well known to those of ordinary skill in the art including, for example, the methods of Hakiel or Mollamahmutoglu, identified above. That computation will produce data 515 of the general type shown in FIG. 3, but other variations are certainly possible. The output from the winding model can be fed into a contact model 530 which, together with data collected previously 505, will produce a force versus deformation curve, K_{code}, which is schematically represented by chart 525.

Next, the data corresponding to Kₜₑₛₜ and K_{code} will be compared. That is, the radial stiffness measured by an embodiment (Kₜₑₛₜ) is compared with a radial stiffness predicted by a combination of winding and contact models (K_{code}). As is indicated by decision item 520, when Kₜₑₛₜ is approximately equal to K_{code}, the residual stresses predicted by the winding model are likely correct and those stresses can be used to predict defects inside and on the surface of the roll.

When Kₜₑₛₜ is different from K_{code}, the winding tension, Tw, needs to be iterated until the two quantities are at least approximately equal. Whatever residual stresses are output by the winding code at that point can be used to predict defects and improve roll quality. The percentage difference between Kₜₑₛₜ and K_{code} that will indicate a need to adjust the winding tension will vary depending on the situation and is intended to be user selectable. It may be that some amount of trial and error will be necessary to establish what an appropriate value would be for a particular scenario. That being said, for purposes of the instant disclosure conditions when Kₜₑₛₜ and K_{code} are different enough to merit modifying Tw will be referred to as a “significant” different or “significantly” different. Alternatively, if Kₜₑₛₜ and K_{code} are not approximately equal (as “approximately” is defined herein), that would also be an instance where they are significantly different.

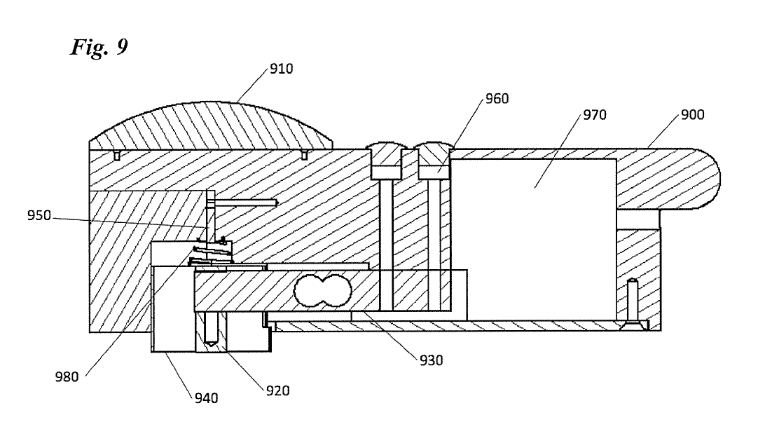

Turning next to FIGS. 9 and 10, these figures contain a cross sectional view and a bottom view of another embodiment. In these embodiments, a user places the unit 900 into contact with the material that is to be measured. By applying a load to press plate 910, the force is communicated through the housing into the load transducer 930, to the indenter 920 which is then pressed into the material. The press plate 910 may also be referred to as a pressure contact area herein.

The displacement ring 940 rests upon the undisturbed face of the material to be measured and is free to translate in the housing of the unit 900 in the axial direction of the indenter 920. The displacement ring 940 is held against the material, and returned to its original position after the test, by spring 980. The relative movement of the displacement ring 940 to that of the indenter 920 is measured by displacement transducer 955. Overload protection of the load transducer 930 may be realized by adjusting the spacing between the load transducer 930 and the housing of the device 900.

In this embodiment, the load is continually measured by a load measuring device such as transducer 930 which transmits or otherwise conveys its measured value to the CPU (not shown). The displacement is measured by the displacement transducer 950 which transmits or otherwise conveys its measured value to the CPU. The CPU processes the load and displacement values to produce a curve similar to that of FIG. 1B. The CPU may further process the data by executing procedures as shown in FIG. 5.

The foregoing are just examples of the many forms that the instant invention might take. For instance, in this recent embodiment the displacement transducer is an optical LED emitter detector pair that is capable or measuring distance. There are numerous load and displacement transducers that could be used and more are being developed every day. Also, some embodiments may not use a displacement ring 940 and, instead, might sense the displacement solely by optical (or other non-contact) means.

In brief, the combination of radial stiffness as measured by embodiments disclosed herein combined with the example approach of FIG. 5 produces a means of improving wound roll quality not available in any other form.

Disclosed herein are embodiments of a test instrument and method for evaluating the quality of a wound roll which will work on all wound web materials. The invention can be further augmented by coupling the output of the instrument with winding and contact models that are used to determine the true winding tensile stress and the actual residual winding stresses that can then be used to estimate roll defects and hence quality.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

For purposes of the instant disclosure, the term “at least” followed by a number is used herein to denote the start of a range beginning with that number (which may be a ranger having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. Terms of approximation (e.g., “about”, “substantially”, “approximately”, etc.) should be interpreted according to their ordinary and customary meanings as used in the associated art unless indicated otherwise. Absent a specific definition and absent ordinary and customary usage in the associated art, such terms should be interpreted to be ±10% of the base value.

When, in this document, a range is given as “(a first number) to (a second number)” or “(a first number)−(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

Still further, additional aspects of the instant invention may be found in one or more appendices attached hereto and/or filed herewith, the disclosures of which are incorporated herein by reference as if fully set out at this point.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. An apparatus for measuring a radial stiffness of a wound roll, comprising:
a. a housing;
b. an indenter, said indenter having a first end external to said housing and a second end internal to said housing;
c. a force sensor within said housing and in mechanical communication with said indenter, said force sensor at least for measuring a force when said force is applied to said housing to urge said indenter against the wound roll;
d. a displacement sensor within said housing, said displacement sensor at least for measuring a displacement of said indenter when said force is applied to said housing to urge said indenter against the wound roll; and,
e. a CPU in electrical communication with said force sensor and said displacement sensor, said CPU at least for reading said force from said force detector and said displacement from said displacement sensor.

2. The apparatus for measuring a radial stiffness of a wound roll according to claim 1, wherein said force sensor is a transducer capable of measuring a load.

3. The apparatus for measuring a radial stiffness of a wound roll according to claim 1, wherein said force sensor is a load cell.

4. The apparatus for measuring a radial stiffness of a wound roll according to claim 1, wherein said displacement sensor is a direct current differential transformer.

5. The apparatus for measuring a radial stiffness of a wound roll according to claim 1, wherein said CPU is internal to said housing.

6. The apparatus for measuring a radial stiffness of a wound roll according to claim 1, wherein said force sensor is selected from the group consisting of a load cell, a force meter, and a spring scale.

7. The apparatus for measuring a radial stiffness of a wound roll according to claim 1, wherein said displacement sensor is selected from the group consisting of a linear variable differential transformer, a linear potentiometers, a rotary potentiometers, an optical displacement device, and a capacitance displacement device.

8. The apparatus for measuring a radial stiffness of a wound roll according to claim 1, further comprising at least one of a WiFi module, a Bluetooth module, a serial port and a USB port.

9. An apparatus for measuring a radial stiffness of an object, comprising:
a. an indenter;
b. a pressure contact area in mechanical communication with said indenter;
c. a force sensor in mechanical communication with said indenter, said force sensor at least for measuring a force when said force is applied to said pressure contact area to urge said indenter against the object;
d. a displacement sensor, said displacement sensor at least for measuring a displacement of said indenter when said force is applied to said pressure contact area to urge said indenter against the object; and,
e. a CPU in electrical communication with said force sensor and said displacement sensor, said CPU at least for continuously reading said force from said force detector and said displacement from said displacement sensor as said force is applied.

10. The apparatus for measuring a radial stiffness of an object according to claim 9, wherein said displacement sensor is a direct current differential transformer.

11. The apparatus for measuring a radial stiffness of an object according to claim 9, wherein said force sensor is a transducer capable of measuring a load.

12. The apparatus for measuring a radial stiffness of an object according to claim 9, wherein said force sensor is selected from the group consisting of a load cell, a force meter, and a spring scale.

13. The apparatus for measuring a radial stiffness of an object according to claim 9, wherein said displacement sensor is selected from the group consisting of a linear variable differential transformer, a linear potentiometers, a rotary potentiometers, an optical displacement device, and a capacitance displacement device.

14. The apparatus for measuring a radial stiffness of an object according to claim 9, further comprising at least one of a WiFi module, a Bluetooth module, a serial port and a USB port.

15. A method of identifying defects in a wound roll of material, comprising the steps of:
a. accessing values of Tw, h, R_{core}, Rₒᵤₜ, E_{θ}, and Eᵣ for said material, where,
Tw is a winding tension of said wound roll,
h is a thickness of caliper of the material,
R_{core} is an outside radius of a core of said wound roll,
Rₒᵤₜ is an inner radius of the wound roll,
E_{θ} is modulus of the material in the machine direction,
Eᵣ is the modulus of the web in the radial direction, and
E_{c} is a modulus of a core on which the material is wound;
b. using a winding model to obtain a relationship between Eᵣ and r, where r is a radial distance from a center of said wound roll;
c. using at least Eᵣ and one or more of Tw, h, R_{core}, Rₒᵤₜ, R_{θ}, and Eᵣ to calculate a contact model, thereby producing one or more values of K_{code}, where K_{code} is a slope of relationship between force and displacement from said contact model;
d. obtaining a plurality of different force and displacement values at a single point on said wound roll;
e. using said plurality of force and displacement values to obtain one or more values of Kₜₑₛₜ at said single point on said wound roll;
f. comparing said one or more value of K_{code} with said one or more values of Ktest;
g. if said one or more K_{code} values are approximately equal to said one or more Kₜₑₛₜ values, conclude that a winding tension is correct; and,
h. if said one or more K_{code} values is significantly different from said one or more Kₜₑₛₜ values, conclude that said winding stress is not correct; and,
i. if said one or more K_{code} values is significantly different from said one or more Kₜₑₛₜ values, modifying Tw and performing steps (a) through (i) again with Tw replaced by said modified Tw until Kₜₑₛₜ is not significantly different from Kcode.

16. A method of obtaining a profile of radial stiffness across a width of a wound roll, wherein is provided the apparatus of claim 9, comprising the steps of:
a. urging said apparatus against said wound roll at a plurality of different locations along a length of said wound roll, thereby obtaining a plurality of force and displacement measurements at each of said plurality of locations;
b. for each of said plurality of force and displacement measurements at each of said plurality of locations, determining a radial stiffness using said force and displacement measurements at that location, thereby obtaining a radial stiffness for each of said plurality of location; and,
c. comparing said plurality of radial stiffnesses with each other to determine if there is a defect in said wound roll.
